(19) United States
(12) Patent Application Publication
(10) Pub. No.: US 2025/0163305 A1
(43) Pub. Date: May 22, 2025

(54) (METH)ACRYLATE-BASED ADHESIVE FOR CORNER ANGLE BONDING

(71) Applicant: SIKA TECHNOLOGY AG, Baar (CH)

(72) Inventors: Denise STORRER, Zürich (CH); Fabien CHOFFAT, Rüttenen (CH)

(73) Assignee: SIKA TECHNOLOGY AG, Baar (CH)

(21) Appl. No.: 18/840,116

(22) PCT Filed: Apr. 5, 2023
(86) PCT No.: PCT/EP2023/058913

§ 371 Date: Aug. 21, 2024

(30) Foreign Application Priority Data
Apr. 7, 2022 (EP) 22167081.3

(51) Int. Cl. C09J 133/10

(52) U.S. Cl. CPC C09J 133/10; C09J 2301/414; C09J 2433/00; C09J 2475/00

(57) ABSTRACT

A two-component composition for use as a free-radically curing adhesive for bonding of corner angles, frames or profiles in window, door, container or vehicle construction. The composition is composed of a component K1 and a component K2. The composition contains at least 50% by weight, preferably between 60% by weight and 75% by weight, of filler based on the mixture of the components K1 and K2. The compositions have good mechanical properties and adhesion to substrates employed in these applications, they additionally have a low viscosity and they can be formulated without volatile, strongly malodorous monomers such as MMA.

### TECHNICAL FIELD

The invention relates to the field of two-component (meth)acrylate compositions and the use thereof as adhesives.

### PRIOR ART

In window and facade construction and in similar applications, where constructional joining of frames and profiles is required, adhesives are used widely to join metal, wood or plastic elements to one another for example. Bonding has various advantages over other securing means such as screws since the joining becomes esthetically and mechanically more stable without screw holes and better sealing, for example against heat and moisture, is also achieved. A classical application in this field is the bonding of corner angles in window profiles which are usually made of aluminum. In such applications the employed adhesive must have a high tensile strength and sufficient stiffness to endow the produced frame with the required stability. Good adhesion, especially to aluminum or alloys thereof, is also necessary. Since, for example, window profiles and similar elements are normally produced industrially, the adhesive must additionally have an open assembly time suitable for an efficient production process and exhibit the fastest possible curing. Today, such processes utilize especially adhesives based on polyurethanes or epoxy resins since these meet the mechanical requirements and are suitable in terms of adhesion to the employed substrates. Industrial bonding usually employs two-component adhesives of this type which, after mixing of the components reactive with one another, undergo rapid curing and allow fast cycle times. US 2017/204311 discloses a two-component polyurethane-based adhesive for example.

However, polyurethane-based adhesives have disadvantages. The isocyanates present therein, especially when they are typically in the form of monomeric diisocyanates as in the case of two-component polyurethanes, are not unconcerning to health and entail ever more additional occupational safety measures, required by law, for their use.

Epoxy resin-based compositions likewise have disadvantages. These especially include the relatively slow curing even in the case of two-component epoxy adhesives if a sufficiently long open assembly time is simultaneously required.

While the curing of epoxy adhesives can be accelerated, for example by heating, this is not desired for industrial processes.

Adhesives having a different chemical basis are typically only rarely used for such applications, if at all. Silicones for example are difficult to paint or coat and are often unsuitable in terms of strength and stiffness. Further adhesives having a different basis are often too expensive to be economically employed in such processes or they have an excessively high viscosity to allow easy application in cracks or cavities, for example by injection.

US 2007/054975 discloses a radiation-curing, one-component adhesive based on acrylate which is especially suitable for bonding of optical elements such as camera lenses. However, the required specific properties for this purpose and the formulation optimized therefor make it relatively costly.

U.S. Pat. No. 4,855,002 discloses a one-component, thermally conductive acrylate-based adhesive containing between 30% by weight and 80% by weight of aluminum powder as filler. This makes it suitable for bonding and heat dissipation in objects with high thermal emission such as electrical components but is likewise costly to formulate and limited in terms of mechanical and adhesive properties. In addition, aluminum powder is not unconcerning in terms of occupational safety.

There therefore remains the need for an adhesive for industrial bonding of corner angles, frames or profiles in window, door, container or vehicle construction which meets the mechanical requirements in terms of tensile strength, modulus of elasticity and adhesion, exhibits a sufficiently long open assembly time and sufficiently fast curing at room temperature and thus enables short cycle times in industrial manufacturing, has a sufficiently low viscosity for easy application by injection for example and/or has an optimal viscosity ensuring that in terms of its components it is homogeneously miscible and injectable including when applied from a cartridge and can be neatly applied in or on the locations intended therefor and is also unconcerning in terms of occupational safety and toxicology.

### SUMMARY OF THE INVENTION

It is accordingly an object of the present invention to provide an adhesive for the bonding of corner angles, frames or profiles in window, door, container or vehicle construction which meets the mechanical requirements in terms of tensile strength, modulus of elasticity and adhesion, exhibits a sufficiently long open assembly time and sufficiently fast curing at room temperature and thus enables short cycle times in industrial manufacturing, has a sufficiently low viscosity for easy application and is also unconcerning in terms of occupational safety and toxicology.

It has now been found that, surprisingly, this object is achieved by the compositions as claimed in claim 1. Despite the unusually high content of fillers the compositions as claimed in claim 1 exhibit excellent adhesion to typically employed materials of corner angles, frames or profiles in window, door, container or vehicle construction, for example aluminum and aluminum alloys such as AlMg₃. Surprisingly, they readily achieve the required mechanical properties here, in particular tensile strength and modulus of elasticity, and they may be applied with sufficiently long open assembly times and, however, subsequently undergo rapid curing at room temperature. These compositions can further be formulated without the use of volatile and odorous (meth)acrylate monomers such as MMA and here exhibit high occupational safety and a favorable EHS profile. Despite the unusually high filler content the compositions are thus optimally suitable for use as adhesives for bonding of corner angles, frames or profiles in window, door, container or vehicle construction and, as a result of their unexpectedly low viscosity, are also applicable by injection processes but at the same time nevertheless do not have such a low viscosity that they can no longer be homogeneously mixed and they flow or spray uncontrollably during application, in particular from a cartridge.

The tensile strengths of the compositions according to the invention measured according to EN 53504 at room temperature (23° C.) are in particular at least 9 MPa, preferably at least 10 MPa, in particular at least 11 MPa or higher, with moduli of elasticity in particular in the range from 700 MPa to 1700 MPa or higher and elongations at break in particular in the range from at least 2% to 15% or higher.

The tensile shear strengths of the compositions according to the invention measured according to ISO 4587/DIN EN 1465 on AlMg₃ at room temperature (23° C.) are in particular at least 2 MPa, preferably at least 3 MPa, in particular at least 4 MPa or higher.

The compositions according to the invention as claimed in claim 1 cure rapidly after application at room temperature, in particular within 20 to 40 minutes, and have here an open assembly time of in particular 5 to 15 minutes, wherein these properties can be influenced and adapted via formulation measures.

The compositions according to the invention as claimed in claim 1 have a low viscosity directly after mixing the components, in particular a viscosity of at most 80 Pa·s, preferably at most 70 Pa·s, in particular at most 50 Pa·s, particularly preferably at most 40 Pa·s or less, measured on a thermostatted rheometer from Anton Paar with Rheoplus software and a plate-plate measurement system (PP25; diameter 25 mm) at 23° C. and at a shear rate of 10 s⁻¹ and a plate spacing of 1.5 mm. At the same time the viscosity of the composition according to the invention should alternatively not be excessively low in order to allow homogeneous mixing and clean application, in particular from a cartridge, upon use as adhesives for bonding of corner angles, frames or profiles in window, door, container or vehicle construction. This is especially the case when the viscosity measurement by the aforementioned method is at least 15 Pa·s, preferably at least 20 Pa·s, particularly preferably at least 25 Pa·s. Lower viscosities can have the result that the composition especially applied from a cartridge flows uncontrollably and for example insufficient layer thicknesses of the adhesive for a mechanically adequate bond are obtained. It is further disadvantageous for the mixing homogeneity of a mixed two-component composition according to the present invention when one of the two components has a much lower viscosity than the other. In this regard it is preferable when the lower-viscosity component of the two-component composition has a viscosity (as defined above) of not less than 10% of the viscosity of the higher-viscosity components, preferably not less than 20%, based on the viscosity of the higher-viscosity component.

Further aspects of the invention are the subject of further independent claims. Particularly preferred embodiments of the invention are the subject of the dependent claims.

### WAYS OF EXECUTING THE INVENTION

The present invention relates to a two-component composition for use as a free-radically curing adhesive for bonding of corner angles, frames or profiles in window, door, container or vehicle construction composed of a component K1 comprising
a) at least one (meth)acrylate monomer A;
b) at least one elastomer C having (meth)acrylate end groups produced from the reaction of at least one diol D, at least one diisocyanate and a (meth)acrylic acid, a (meth)acrylamide or a (meth)acrylate ester having a hydroxyl group;
c) at least one activator for free-radical curing;
d) preferably at least one inhibitor for free-radical curing;
e) at least one filler;
f) and optionally further additives;
and a component K2 comprising
g) at least one initiator for free-radical curing;
h) preferably at least one filler;
i) preferably at least one plasticizer;
j) and optionally further additives;
characterized in that the composition contains at least 50% by weight, preferably between 60% by weight and 75% by weight, of filler based on the mixture of the components K1 and K2.

In the present document substance names beginning with “poly”, for example polyisocyanate, polyurethane, polyester or polyol, refer to substances formally containing two or more of the eponymous functional groups per molecule.

The term “polymer” in the present document encompasses firstly a collective of macromolecules that are chemically uniform, but differ in their degree of polymerization, molar mass, and chain length, said collective having been prepared by a poly reaction (polymerization, polyaddition, polycondensation). The term secondly also encompasses derivatives of such a collective of macromolecules from “poly” reactions, i.e. compounds obtained by reactions, for example additions or substitutions, of functional groups in defined macromolecules and which may be chemically uniform or chemically nonuniform. The term moreover also encompasses so-called prepolymers, i.e. reactive oligomeric preliminary adducts whose functional groups are involved in the formation of macromolecules.

The term “polymeric polyol” in the present document encompasses any polymer as defined above which comprises more than one hydroxyl group. Accordingly, the term “polymeric diol” encompasses any polymer having precisely two hydroxyl groups.

The term “polyurethane polymer” encompasses all polymers produced by the so-called diisocyanate polyaddition process. This also includes polymers that are virtually or completely free from urethane groups. Examples of polyurethane polymers are polyether polyurethanes, polyester polyurethanes, polyether polyureas, polyureas, polyester polyureas, polyisocyanurates, and polycarbodiimides.

“Molecular weight” in the present document is to be understood as meaning the defined and discrete molar mass (in grams per mole) of a molecule or part of a molecule, also referred to as a “radical”. “Average molecular weight” denotes the number-average Mₙ of an oligomeric or polymeric mixture, especially a polydisperse mixture, of molecules or radicals, which is typically determined by gel-permeation chromatography (GPC) against a polystyrene standard.

The term “(meth)acrylate” is to be understood as meaning “methacrylate” or “acrylate”.

A dashed line in the formulae in this document in each case represents the bond between a substituent and the accompanying molecular radical unless otherwise stated.

“Room temperature” refers to a temperature of approx. 23° C.

Unless otherwise stated, all industry standards or other standards mentioned in this document relate to the version of the industrial standard or other standard that was valid at the time of filing of the patent application.

The terms “mass” and “weight” are used synonymously in this document. Thus a “percentage by weight” (% by weight) is a percentage proportion by mass which, unless stated otherwise, refers to the mass (weight) of the overall composition or, depending on the context, of the entire molecule.

The two-component composition according to the invention consists of a first component K1 and a second component K2.

Component K1 firstly comprises at least one (meth)acrylate monomer A.

(Meth)acrylate monomer A may comprise all (meth)acrylate monomers typically employed in (meth)acrylate adhesives.

However, (meth)acrylate monomer A preferably does not comprise methyl methacrylate (MMA) since this is problematic in respect of its high vapor pressure, highly flammable nature, unpleasant odor and questionable health effects.

(Meth)acrylate monomer A especially comprises at least one (meth)acrylate monomer according to formula (IIIa),

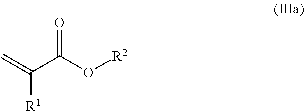

wherein R¹ is either a hydrogen atom or a methyl group, preferably a methyl group;
R² is either an isobornyl group or a linear or branched hydroxyalkyl group having 2 to 6 carbon atoms or a radical having 4 to 8 carbon atoms comprising either a phenyl group or an aliphatic 5- or 6-membered ring with at least one ether oxygen in the ring structure.
R¹ in formula (IIIa) is preferably a methyl group.

In a preferred embodiment R² in formula (IIIa) is a linear or branched hydroxyalkyl group having 2 to 4 carbon atoms. Examples of such monomers are hydroxypropyl acrylate (HPA), hydroxypropyl methacrylate (HPMA), hydroxybutyl acrylate (HBA) or hydroxybutyl methacrylate (HBMA), preferably hydroxyethyl acrylate (HEA) or hydroxyethyl methacrylate (HEMA), wherein hydroxyethyl methacrylate (HEMA) is particularly preferred.

In another preferred embodiment R² in formula (IIIa) is a radical having 4 to 8 carbon atoms which comprises an aliphatic 5- or 6-membered ring having one or two ether oxygens in the ring structure.

In another preferred embodiment R² in formula (IIIa) is an isobornyl group.

It is most preferable when R² in formula (IIIa) is an isobornyl group or a hydroxyethyl group or a benzyl group or at least one of the groups (IVa) to (IVc) in formula (IV),

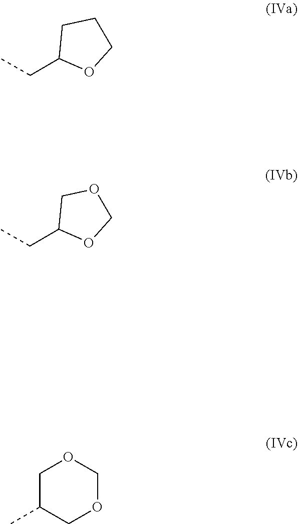

wherein the dashed lines in formula (IV) represent the bond between the oxygen atom and R². Examples of such preferred monomers are isobornyl acrylate (IBOA), isobornyl methacrylate (IBOMA), benzyl acrylate (BNA), benzyl methacrylate (BNMA), hydroxyethyl acrylate (HEA), hydroxyethyl methacrylate (HEMA), tetrahydrofurfuryl methacrylate (THFMA) and the isomer mixture glycerol formal methacrylate (comprising the structures (IVb) and (IVc) in formula (IV); CAS-No. 1620329-57-8) which is available from Evonik under the trade name GLYFOMA.

The most preferred monomers according to formula (iIla) are isobornyl methacrylate (IBOMA), benzyl methacrylate (BNMA), tetrahydrofurfuryl methacrylate (THFMA), hydroxyethyl methacrylate (HEMA) and glycerol formyl methacrylate (GLYFOMA).

It goes without saying that mixtures of these monomers according to formula (IIIa) may also be employed.

(Meth)acrylate monomer A especially comprises at least one (meth)acrylate monomer according to formula (IIIb),

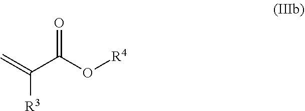

wherein R³ is either a hydrogen atom or a methyl group, preferably a methyl group, and
R⁴ is a linear alkyl radical having more than 12 carbon atoms in the chain and preferably at most 20 carbon atoms in the chain.
R³ in formula (IIIb) is preferably a methyl group.
R⁴ in formula (IIIb) is preferably a linear alkyl radical having 13 to 18 carbon atoms in the chain. If there is a mixture of different chain lengths in the radical R⁴ the average value of the chain lengths is formally used as a measure of the effective chain length in R⁴.

Examples of such (meth)acrylate monomers according to formula (IIIb) include lauryl tetradecyl acrylate (LATEA), lauryl tetradecyl methacrylate (LATEMA), stearyl acrylate (STEA) and stearyl methacrylate (STEMA). Lauryl tetradecyl methacrylate (LATEMA) and stearyl methacrylate (STEMA) are most preferred.

Component K1 preferably contains between 10% by weight and 25% by weight, preferably between 10% by weight and 20% by weight, based on component K1, of (meth)acrylate monomer A.

If mixtures of (meth)acrylate monomers according to formula (IIIa) and (meth)acrylate monomers according to formula (IIIb) are used as (meth)acrylate monomer A the weight ratio of (meth)acrylate monomers according to formula (IIIa) and (meth)acrylate monomers according to formula (IIIb) is preferably between 1:1 and 9:1, preferably between 6:4 and 8:2. Within these limits it is possible to achieve improved elasticity both at room temperature and at very low temperatures down to −20° C.

Component K1 further contains at least one elastomer C having (meth)acrylate end groups produced from the reaction of at least one diol D, at least one diisocyanate and a (meth)acrylic acid, a (meth)acrylamide or a (meth)acrylate ester having a hydroxyl group.

The elastomer C preferably has an average molecular weight of 1000 to 40 000 g/mol, in particular of 2000 to 30 000 g/mol, preferably of 3000 to 20 000 g/mol.

The elastomer C is thus a polyurethane (meth)acrylate. Such compounds are typically producible from the reaction of at least one diol D with at least one diisocyanate and one (meth)acrylic acid, one (meth)acrylamide or one (meth)acrylate ester having a hydroxyl group. Elastomer C is preferably produced from a polyoxypropylene diol and at least one diisocyanate and a (meth)acrylate ester having a hydroxyl group.

In a first process this reaction may be carried out by reacting the diol D and the diisocyanate by customary processes, for example at temperatures of 50° C. to 100° C., optionally with co-use all suitable catalysts, ensuring that the NCO groups are present in stoichiometric excess relative to the OH groups. The isocyanate-terminated polyurethane polymer resulting from this reaction is then reacted with a (meth)acrylic acid, a (meth)acrylamide or with a (meth)acrylate ester having a hydroxyl group, in particular with a hydroxyalkyl (meth)acrylate such as hydroxypropyl acrylate (HPA), hydroxypropyl methacrylate (HPMA), hydroxybutyl acrylate (HBA) or hydroxybutyl methacrylate (HBMA) preferably with hydroxyethyl acrylate (HEA) or hydroxyethyl methacrylate (HEMA), or with a monohydroxypoly(meth)acrylate of a polyol, preferably of glycerol or trimethylolpropane, to afford a polyurethane(meth)acrylate.

In a second process the diol D may be reacted with the diisocyanate, wherein the OH groups are present in stoichiometric excess relative to the NCO groups. The isocyanate-terminated polyurethane polymer resulting from this reaction may be esterified with a (meth)acrylic acid to afford the elastomer C of formula (I).

A further process for producing the elastomer C comprises a first step of reacting the (meth)acrylic acid, the (meth)acrylamide or the (meth)acrylate ester having a hydroxyl group, in particular hydroxyalkyl (meth)acrylate such as hydroxypropyl acrylate (HPA), hydroxypropyl methacrylate (HPMA), hydroxybutyl acrylate (HBA) or hydroxybutyl methacrylate (HBMA), preferably hydroxyethyl acrylate (HEA) or hydroxyethyl methacrylate (HEMA), or a monohydroxypoly(meth)acrylate of a polyol, preferably of glycerol or trimethylolpropane, with at least one diisocyanate which is employed in an amount such that the NCO groups are present in excess relative to the OH groups. In a subsequent reaction the resulting intermediate comprising an isocyanate group is reacted with at least one diol D to afford the elastomer C.

It is also possible to produce the elastomer C by esterification of a (meth)acrylic acid with a diol D, wherein the diol is in stoichiometric excess. In a subsequent reaction the partially esterified diol D reacts with a diisocyanate to afford the elastomer C.

Preferred diols D are polyoxyalkylene diols, also known as “polyether diols”, polyester diols, polycarbonate diols and mixtures thereof. The most preferred diols are polyoxyethylene diols, polyoxypropylene diols or polyoxybutylene diols.

The polyoxyalkylene diols may have different degrees of unsaturation (measured according to ASTM D-2849-69 and reported in milliequivalents of unsaturation per gram of polyol (mEq/g)). Those with a low degree of unsaturation are produced for example using so-called double metal cyanide complex catalysts (DMC catalysts) while those with a higher degree of unsaturation are produced for example using anionic catalysts such as NaOH, KOH, CsOH or alkali metal alkoxides.

The use of polyoxyalkylene diols having a low degree of unsaturation, in particular of less than 0.01 mEq/g, is preferred for diols having a molecular weight of >2000 g/mol. Such diols are obtainable from Covestro under the trade name Acclaim® Polyol for example. Of these, Acclaim® Polyol 4200 and 12200 N are preferred.

Diisocyanates suitable for the production of elastomer C in principle include all diisocyanates. Examples include hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, lysine and lysine ester diisocyanate, cyclohexane 1,3-diisocyanate, cyclohexane 1,4-diisocyanate, 1-isocyanato-3,3,5-trimethyl-5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis(1-isocyanato-1-methylethyl)naphthalene, tolylene 2,4-diisocyanate and 2,6-diisocyanate (TDI), diphenylmethane 4,4′-diisocyanate, 2,4′-diisocyanate, and 2,2′-diisocyanate (MDI), phenylene 1,3-diisocyanate and 1,4-diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), oligomers and polymers of the abovementioned isocyanates and also any desired mixtures of the abovementioned isocyanates. 1-isocyanato-3.3,5-trimethyl-5-isocyanatomethyl-cyclohexane (IPDI) is a preferred diisocyanate.

It is most preferable when elastomer C is a polyurethane (meth)acrylate, in particular producible from the reaction of at least one diol D, in particular a polyoxypropylene diol, with at least one diisocyanate and one (meth)acrylate ester having a hydroxyl group, wherein
the diol D reacts with a diisocyanate, in particular isophorone diisocyanate, which is present in stoichiometric excess,
and the resulting isocyanate-terminated polyurethane is reacted with the (meth)acrylate ester having a hydroxyl group, in particular with a hydroxyalkyl (meth)acrylate, preferably with hydroxyethyl acrylate (HEA) or hydroxyethyl methacrylate (HEMA), to afford the elastomer C of formula (I).

During the reaction the OH groups of the diol D react with the isocyanate groups of the monomeric diisocyanate. This also results in so-called chain extension reactions comprising reaction of OH groups and/or isocyanate groups of reaction products between diol D and monomeric diisocyanate. The higher the NCO:OH ratio chosen, the lower the level of chain extension reactions that takes place, and the lower the polydispersity and hence also the viscosity of the polymer obtained. A measure of the chain extension reaction is the average molecular weight of the polymer, or the breadth and distribution of the peaks in the GPC analysis. A further measure is the effective NCO content of the polymer freed from monomers relative to the theoretical NCO content calculated from the reaction of every OH group with a monomeric diisocyanate.

A suitable NCO:OH ratio in the reaction of diol D and diisocyanate is for example in the range from 1:1 to 10:1, in particular 1.1:1 to 1.25:1.

In a further embodiment of the reaction of diol D and diisocyanate an NCO:OH ratio of at least 3:1 is established.

The NCO:OH ratio is preferably in the range from 3:1 to 10:1, more preferably 3:1 to 8:1, especially 4:1 to 7:1, most preferably 5:1 to 7:1.

In all embodiments the reaction is preferably performed here in the absence of moisture at a temperature in the range from 20 to 160° C., in particular 40 to 140° C., optionally in the presence of suitable catalysts.

If necessary the monomeric diisocyanate remaining in the reaction mixture is removed down to the desired residual content using a suitable separation method after the reaction.

A preferred separation method in such cases is a distillative method, in particular thin-film distillation or short path distillation, preferably with application of vacuum. Particular preference is given to a multistage method in which the monomeric diisocyanate is removed in a short-path evaporator with a jacket temperature in the range from 120° C. to 200° C. and a pressure of 0.001 to 0.5 mbar.

In the case of 4,4′-MDI, which is preferred as monomeric diisocyanate, distillative removal is particularly demanding. It has to be ensured, for example, that the condensate does not solidify and block the system. Preference is given to operating at a jacket temperature in the range from 160° C. to 200° C. at 0.001 to 0.5 mbar and condensing the monomer removed at a temperature in the range from 40° C. to 60° C.

Preference is given to reacting the monomeric diisocyanate with the diol D and subsequently removing the majority of the monomeric diisocyanate remaining in the reaction mixture without the use of solvents or entraining agents.

Preference is given to subsequently reusing the monomeric diisocyanate removed after the reaction, i.e. using it again for the production of isocyanate-containing polymer.

In addition to the aforementioned diols, diol D may also comprise further diols, in particular:
polyester diols, especially from the polycondensation of hydroxycarboxylic acids or especially those produced from dihydric alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, 1,4-cyclohexanedimethanol, dimer fatty acid diol (dimer diol), neopentyl glycol hydroxypivalate, glycerol or mixtures of the aforementioned alcohols with organic dicarboxylic acids or anhydrides or esters thereof, such as especially succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid or mixtures of the aforementioned acids, and also polyester polyols formed from lactones such as especially F-caprolactone and starters such as the aforementioned dihydric alcohols.
dimer fatty acid-based polyester diols, especially those which have an average molecular weight Mn in the range of 950 to 4000 g/mol and are amorphous (commercially available under the name Priplast® from Croda for example).
polycarbonate diols, as obtainable by reaction for example of the aforementioned alcohols used to form the polyester polyols with dialkyl carbonates, diaryl carbonates or phosgene.
block copolymers bearing two hydroxyl groups and comprising at least two different blocks of polyether, polyester and/or polycarbonate structure of the the above-described type, especially polyether polyester diols.
polyacrylate and polymethacrylate diols.
polyhydrocarbon diols, also known as oligohydrocarbonols, such as, for example, dihydroxy-functional polyolefins, polyisobutylenes, polyisoprenes; dihydroxy-functional ethylene/propylene, ethylene/butylene or ethylene/propylene/diene copolymers, as produced, for example, by Kraton Polymers; dihydroxy-functional polymers of dienes, especially of 1,3-butadiene, which can especially also be prepared from anionic polymerization; dihydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example dihydroxy-functional acrylonitrile/butadiene copolymers, as may be produced, for example, from epoxides or aminoalcohols and carboxyl-terminated acrylonitrile/butadiene copolymers (commercially available, for example, under the name Hypro® CTBN or CTBNX or ETBN from Emerald Performance Materials); and hydrogenated dihydroxy-functional polymers or copolymers of dienes.

It is preferable when in component K1 the composition additionally contains between 0.5% by weight and 5% by weight, based on component K1, of an adhesion promoter, in particular selected from the group of organosilanes, metal (meth)acrylates, preferably metal (meth)acrylates of calcium, magnesium or zinc, polyfunctional (meth)acrylates having more than two (meth)acrylate groups and (meth)acrylates of formula (II).

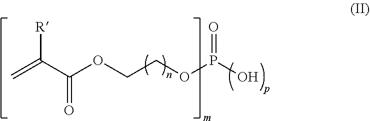

The radical R′ is either a hydrogen atom or a methyl group, n represents a value from 1 to 15, in particular from 1 to 5, preferably from 1 to 3, m represents a value from 1 to 3 and p represents a value of 3 minus m.

Preferred metal (meth)acrylates are metal (meth)acrylates of calcium, magnesium or zinc having a hydroxyl group and/or (meth)acrylic acid or (meth)acrylate as a ligand or anion. Particularly preferred metal (meth)acrylates are zinc (meth)acrylates, calcium (meth)acrylates, Zn (OH)(meth)acrylates and magnesium (meth)acrylates.

Preferred (meth)acrylates of formula (II) are 2-methacryloyloxyethyl phosphate, bis(2-methacryloyloxyethyl)phosphate and tris(2-methacryloyloxyethyl)phosphate and mixtures thereof.

Preferred organosilanes are epoxy-functional silanes, in particular 3-glycidoxypropyltrimethoxysilane.

Adhesion promoters are used to improve adhesion to special substrates. The use of phosphorus-containing (meth)acrylates according to formula (II) is especially advantageous for metal surfaces (aluminum, anodized aluminum etc.).

Organosilanes improve adhesion to glass and ceramic surfaces.

Metal (meth)acrylates are also advantageous for bonding to metal surfaces for example.

It goes without saying that mixtures of different adhesion promoters may also be employed.

The proportion of the adhesion promoter optionally present in component K1 is by preference between 1 and 5% by weight, preferably between 1.5 and 3% by weight, based on component K1.

Furthermore the composition in component K1 may preferably additionally contain at least one core-shell polymer. Core-shell polymers consist of an elastic core polymer (core) and a rigid shell polymer (shell). Especially suitable core-shell polymers consist of a rigid shell of a rigid thermoplastic polymer grafted onto a core of crosslinked elastic acrylate or butadiene polymer.

Particularly suitable core-shell polymers are those which swell up in the (meth)acrylate monomer A but do not dissolve therein.

Preferred core-shell polymers are so-called MBS polymers which are commercially available for example under the trade name Clearstrength® from Arkema Inc., USA, or Paraloid® from Rohm and Haas, USA. The core-shell polymers are preferably employed in an amount of 0.01% to 30% by weight, in particular from 5% to 10% by weight, based on component K1.

Furthermore, the composition in component K1 additionally contains at least one activator for free-radical curing, also referred to as a catalyst. The activator is in particular a tertiary amine, a transition metal salt or a transition metal complex.

Examples of such suitable tertiary amines are N,N-dimethylaniline, N,N-diethylaniline, N,N-dimethyl-p-toluidine, N,N-diethyl-p-toluidine, N-methyl-N-hydroxyethyl-p-toluidine, N,N-bis(2-hydroxyethyl)-p-toluidine and alkoylated N,N-bis(hydroxyethyl)-p-toluidines, N-ethoxylated p-toluidine, N-alkylmorpholine and mixtures thereof. Transition metal salts and transition metal complexes are for example salts and complexes of cobalt, nickel, copper, manganese or vanadium. Mixtures of such substances may also be used as activator. N,N-bis(2-hydroxyethyl)-para-toluidine is most preferred as activator.

The activator is preferably employed in an amount of 0.01 to 2.5% by weight, in particular from 0.5 to 2.0% by weight, based on component K1.

It is preferable when the composition in component K1 additionally contains an inhibitor for free-radical curing. This is selected from substances which slightly retard or moderate the free-radical mechanisms of curing or inhibit undesired curing reactions (for example UV light- or atmospheric oxygen-induced mechanisms), thus leading to improved storage stability and/or a more controlled, more uniform curing.

It is preferable when the component K1 contains between 0.001% by weight and 0.5% by weight, preferably between 0.01% by weight and 0.25% by weight, based on component K1, of at least one inhibitor for free-radical curing, in particular an alkylated phenol, preferably 2,6-di-tert-butyl-p-cresol.

Furthermore, component K1 additionally contains at least one filler. It must contain sufficient filler for the composition to have a filler content of at least 50% by weight after mixing of the components. Especially suitable fillers include natural, ground or precipitated calcium carbonates (chalks), which are optionally coated with fatty acids, in particular stearates, montmorillonites, bentonites, barium sulfate (BaSO₄, also known as barite or heavy spar), calcined kaolins, quartz flour, aluminum oxides, aluminum hydroxides, silicas, in particular pyrogenic silicas, modified castor oil derivatives and polymer powders or polymer fibers. Preference is given to calcium carbonates, especially ground and optionally coated calcium carbonates. The filler most preferred is calcium carbonate.

The filler is preferably employed in an amount of between 50% by weight and 85% by weight, preferably between 55% by weight and 80% by weight, in particular between 60% by weight and 75% by weight, based on component K1.

The second component K2 of the two-component composition comprises at least one initiator for free-radical curing. The initiator is a free-radical former that forms reactive free-radicals, thus initiating the free-radical curing mechanism of the monomers in component K1.

Molecules suitable as such free-radical formers are in particular those which, under the influence of heat or electromagnetic radiation, form free-radicals which then result in polymerization of the composition.

Free-radical formers especially include thermally activatable free-radical formers and photoinitiators.

Preferred thermally activatable free-radical formers especially include those which are still sufficiently stable at room temperature but form radicals at even slightly elevated temperature. Such free-radical formers include in particular a peroxide, a perester or a hydroperoxide. Organic peroxides are preferred. Dibenzoyl peroxide is most preferred.

Photoinitiators are free-radical formers which form free-radicals under the influence of electromagnetic radiation. Especially suitable photoinitiators include those which form free radicals upon irradiation with electromagnetic radiation having a wavelength of 230 nm to 400 nm and are liquid at room temperature. It is particularly preferable when the photoinitiator is selected from the group consisting of α-hydroxyketones, phenylglyoxylates, monoacylphosphines, diacylphosphines, phosphine oxides and mixtures thereof, in particular 1-hydroxycyclohexylphenylketone, benzophenone, 2-hydroxy-2-methyl-1-phenylpropanone, methylphenyl glyoxylate, oxyphenylacetic acid 2-[2-oxo-2-phenyl-acetoxyethoxy]ethyl ester, oxyphenylacetic acid 2-[2-hydroxyethoxy]ethyl ester, diphenyl(2,4,6-trimethylbenzoyl)phosphine oxide, phenylbis(2,4,6-trimethylbenzoyl)phosphine oxide and mixtures thereof. Such photoinitiators are for example commercially available from the IRGACURE® and DAROCUR® product lines of Ciba Speciality Chemicals, Switzerland.

Mixtures of photoinitiators may also be used.

Component K2 of the two-component composition preferably contains between 5% by weight and 75% by weight, in particular between 10% by weight and 50% by weight, based on component K2, of the at least one initiator for free-radical curing, wherein said initiator is especially a thermally activatable free-radical former, preferably a peroxide, a hydroperoxide or a perester, most preferably dibenzoyl peroxide,
or wherein said initiator is a photoinitiator, in particular a photoinitiator which forms free radicals upon irradiation with electromagnetic radiation having a wavelength of 230 nm to 400 nm.

Dibenzoyl peroxide is most preferred as the initiator in component K2. This is preferably employed dispersed in a plasticizer or another inert carrier.

Component K2 of the composition according to the invention preferably additionally contains at least one additive selected from the group consisting of plasticizer, filler, thixotropic additive and colorant, in particular all of these additives.

Suitable plasticizers include all nonreactive substances which are liquid at room temperature and typically employed in this function. Oleochemical plasticizers such as castor oil are preferred.

Suitable fillers include for example the same fillers as described for component K1.

Suitable colorants include nonreactive organic dyes and pigments.

Suitable thixotropic additives include all such additives typically used in (meth)acrylate compositions.

The composition may optionally also contain further constituents in one or both components K1 and K2. Such additional components include impact modifiers, dyes, pigments, inhibitors, UV- and heat stabilizers, metal oxides, antistats, flame retardants, biocides, plasticizers, waxes, leveling agents, adhesion promoters, thixotropic agents and further common raw materials and additives known to a person skilled in the art.

In a particularly preferred embodiment of the two-component composition according to the invention component K1 of the composition comprises, in each case based on component K1,
a) between 10% by weight and 20% by weight of (meth)acrylate monomer A, in particular hydroxyethyl methacrylate and/or benzyl methacrylate;
b) between 5% by weight and 15% by weight of elastomer C;
c) between 0.5% by weight and 2.5% by weight of the activator for free-radical curing, in particular a tertiary aromatic amine;
d) between 0.001% by weight and 0.5% by weight of the inhibitor for free-radical curing, in particular an alkylated phenol;
e) between 50% by weight and 80% by weight of fillers, in particular chalk;
f) and optionally further additives, in particular between 0.5% by weight and 5% by weight of at least one adhesion promoter.

In the same or another particularly preferred embodiment of the two-component composition according to the invention component K2 of the composition comprises, in each case based on component K2,
g) between 5% by weight and 50% by weight of the initiator for free-radical curing, in particular dibenzoyl peroxide;
h) between 10% by weight and 75% by weight of filler, in particular chalk;
i) between 10% by weight and 40% by weight of plasticizer, in particular oleochemical plasticizers;
j) and optionally further additives, in particular thixotropic agents and pigments.

Particular preference is given to a two-component composition composed of a component K1 as described above and a component K2 as described above in a volume ratio K1:K2 of 1:1 to 10:1.

The composition according to the invention is always a two-component composition, wherein the two components K1 and K2 thereof are stored separately from one another until application. The first component K1 especially includes those ingredients of the described composition which comprise free-radically polymerizable groups. The second component K2 especially includes the free radical formers, also known as initiators. A two-component composition also makes it possible to effect separate storage of other constituents, in particular those that impair the reaction through reaction with one another.

In described two-component compositions it is typically the case that the component K1 comprises the constituents monomers, elastomers, activators, inhibitors, adhesion promoters and fillers and the component K2 comprises the constituents initiators, optionally pigments, plasticizers and fillers. The volume mixing ratio of K1 to K2 is especially in the range from 1:1 to 10:1.

In certain cases it may be advantageous give the two components K1 and K2 different colors. This allows the mixing quality to be checked during mixing of the components and mixing errors can be detected at an early stage. This measure also allows qualitative checking of whether the intended mixing ratio has been observed.

A further aspect of the invention relates to a package composed of a packaging and packaged material.

The packaging comprises two chambers separated from one another. The packaged material is a two-component free-radically cured composition consisting of a first component K1 and a second component K2 as described above.

Component K1 is in one chamber of the packaging and component K2 is in the other chamber of the packaging.

The packaging especially formed the unit in which the two chambers are held together or directly bound to one another.

The separating means between the chambers may for example be a film or a breakable layer or one or two closures sealing an opening. In a preferred embodiment the packaging is a double cartridge.

Such cartridge packagings are prior art for two-component compositions and disclosed for example in WO2008151849.

A further packaging option is a multi-chamber tubular bag or a multi-chamber tubular bag with an adapter, as disclosed for example in WO 01/44074 A1.

It is preferable when the mixing of the two components K1 and K2 is effected using a static mixer which may be attached to the packaging with two chambers preferably used for this process.

In an industrial-scale plant, the two components K1 and K2 are typically stored separately from one another in vats or hobbocks and expressed and mixed on application, for example using gear pumps. The composition may be applied to a substrate manually or in an automated process using a robot.

The composition according to the invention has a low viscosity both in terms of the two components K1 and K2 and, particularly advantageously, in terms of the mixture of these two components. The composition according to the invention may thus readily be applied by machine or by hand. In preferred embodiments the freshly mixed mixture of the two components has a viscosity of at most 70 Pa·s, in particular at most 50 Pa·s, particularly preferably at most 40 Pa·s, measured according to the method described further above. Such low-viscosity compositions having a viscosity of at most 70 Pa·s or less are particularly readily suitable for bonding of corner angles, frames or profiles in window, door, container or vehicle construction, especially if the composition is to be sprayed or injected into cavities or gaps.

The invention further comprises the use of a composition as described hereinabove as an adhesive or sealant or for producing coatings, in particular as a structural adhesive. Particular preference is given to the use of a two-component composition according to the invention as a free-radically curable adhesive, in particular for bonding of corner angles, frames or profiles in window, door, container or vehicle construction.

The substrate on whose surface the mixed composition is applied may have been subjected to prior treatment with suitable pretreatment or cleaning agents. It is particularly suitable to effect pretreatment/cleaning of the substrates with Sika®Cleaner P or Sika® ADPrep which are commercially available from Sika Schweiz AG.

The pretreatment of the substrates with primers and/or adhesion promoters may be useful in certain cases but compositions according to the invention have proven particularly advantageous because they may be applied primerlessly to numerous substrates, in particular to plastics such as PVC and metals such as aluminum or alloys without adverse effects on adhesion.

The invention further comprises a process for bonding substrates S1 and S2 comprising the steps of
i) applying a composition as described above to a substrate S1;
ii) contacting the applied composition with a second substrate S2 within the open assembly time;
   or
i′) applying a composition as described above to a substrate S1;
ii′) applying a composition as described above to a substrate S2;
iii′) joining the two substrates S1 and S2 to which composition has been applied within the open assembly time;
   wherein the second substrate S2 is composed of a material identical or different to that of substrate S1. A step I) of the at least partial mixing of the two components is carried out here before or during step i) or i′) and ii′).

The present invention further provides a cured composition obtained from an above-described composition by a curing process. In cured form the composition has the feature that it does not exhibit viscoelastic behavior and that compressive stress results in no, or almost no, plastic deformation of the composition.

The invention further comprises articles bonded or sealed by an above-described process. These articles are preferably a built structure, in particular an above- or below-ground built structure, or an industrial product or a consumer good, in particular a window, a domestic appliance, a tool or a means of transport, in particular a vehicle for travelling on water or land, preferably an automobile, a bus, a truck, a train or a ship. Such articles are preferably also attachable components for industrial products or means of transport, in particular also modular parts, which are used as modules on the manufacturing and in particular attached or installed by bonding. These prefabricated attachable components are especially employed in the construction of means of transport. Such attachable components include for example drivers cabs of trucks or of locomotives or sunroofs of automobiles. These articles are preferably windows and doors, such as are used in built structures.

### EXAMPLES

Examples illustrating the invention are described below.

### Production of an Elastomer C

The elastomer C1 was produced as follows:

849 g of polyoxypropylene diol (Acclaim® 4200, Covestro; OH number 60 KOH/g) and 101 g of 1-isocyanato-3,3,5-trimethyl-5-isocyanatomethylcyclohexane (=isophorone diisocyanate or IPDI; Desmodur® I, Bayer MaterialScience) were reacted at 60° C. to afford an isocyanate-terminated polyurethane polymer having a titrimetrically determined content of free isocyanate groups of 1.88% by weight.

This was followed by addition of 10 g of hydroxyethyl methacrylate (HEMA) which reacted with the free isocyanate groups of the polyurethane polymer to afford the elastomer C1.

### Production of the Compositions

The following compositions were produced:

As component K1 to be tested in each case, the constituents specified in table 2 in the reported amounts were mixed with one another and incorporated in a dissolver at a temperature of at most 80° C. until a macroscopically homogeneous paste was obtained.

As component K2 20% by weight of dibenzoyl peroxide-containing paste (comprising 50% by weight of peroxide in an inert carrier), 26.5% by weight of castor oil as plasticizer, 50.5% by weight of chalk, 2.5% by weight of thixotropic agent and 0.5% by weight of a pigment were mixed with one another in a dissolver. This component K2 was used equally with the respective component K1 from table 2 for all experiments.

The produced components K1 and K2 were filled into the separate chambers of coaxial cartridges and, in use, employed in a K1:K2 volume ratio of 10:1.

### Description of the Test Methods

The tensile strength, the elongation at break and the modulus of elasticity in the range of 0.025-0.05% elongation (elastic modulus) were determined according to DIN EN 53504 (extension rate: 200 mm/min) on films having a layer thickness of 2 mm which were cured in advance over 7 days under standard climactic conditions (23±1° C., 50±5% relative humidity).

The adhesion of the adhesive was tested by measuring the tensile shear strength. The tensile shear strength was determined here based on ISO 4587/DIN EN 1465 on a Zwick/Roell Z010 tensile tester, in each case using untreated AlMg₃ substrates (adhesive surface: 15×45 mm; film thickness: 1.6 mm; measuring rate: 10 mm/min; temperature: 23° C.). Before measurement after application of the adhesive the bonded substrates were cured over 7 days under standard climactic conditions (23±1° C., 50±5% relative humidity).

The viscosity was measured on a thermostatted rheometer from Anton Paar with Rheoplus software and a plate-plate measurement system (PP25; diameter 25 mm). The viscosity was always measured at 23° C. and a shear rate of 10 s⁻¹ and a plate spacing of 1.5 mm.

The results of the measurements are summarized in table 3.

TABLE 2
Components according to the invention K1 (E1 and E2). All figures
in percent by weight based on the respective component K1.

| Example | E1 | E2 | V1 | V2 |
|---|---|---|---|---|
| 2-Hydroxyethyl methacrylate (HEMA) | 14.52 | — | 61.46 | — |
| Benzyl methacrylate (BNMA) | — | 14.52 | — | 61.46 |
| Inhibitor ¹ | 0.1 | 0.06 | 0.06 | 0.06 |
| Elastomer C1 | 11.9 | 11.94 | 15.0 | 15.0 |
| Adhesion promoter ² | 2.5 | 2.5 | 2.5 | 2.5 |
| Filler (chalk) ³ | 70.0 | 70.0 | 20.0 | 20.0 |
| Activator ⁴ | 0.98 | 0.98 | 0.98 | 0.98 |

¹ 2,6-di-tert-butyl-p-cresol;
² zinc dimethacrylate (Dymalink ® 708 (Cray Valley);
³ Omyacarb ® 5 GU (Omya);
⁴ N,N-bis(2-hydroxyethyl)-para-toluidine.

TABLE 3
Test results for the example compositions produced.

| Example | E1 | E2 | V1 | V2 |
|---|---|---|---|---|
| Tensile strength (MPa) | 11.6 | 11.8 | n.d. | n.d. |
| Elongation at break (%) | 2 | 14 | n.d. | n.d. |
| Modulus of elasticity (MPa) | 1610 | 770 | n.d. | n.d. |
| Tensile shear strength (MPa) | 2 | 4 | n.d. | n.d. |
| Viscosity component K1 (Pa · s) | 60 | 30 | 2 | 1 |
| Viscosity component K2 (Pa · s) | 150 | 150 | 150 | 150 |
| Viscosity mixture 10:1 K1 + K2 (Pa · s) | 70 | 40 | 14 | 10 |

«n.d.» means that this value has not been measured.

The results in table 3 show that the compositions according to the invention are mechanically and adhesively suitable for bonding of corner angles, frames or profiles in window, door, container or vehicle construction despite the extremely high filler content. In addition, the compositions, especially in the mixture of their respective components, have an extraordinarily low viscosity which also makes them suitable for application by injection without special application apparatuses.

Especially composition E2 based on benzyl methacrylate (BNMA) exhibits not only particularly good mechanical properties but also particularly good adhesion and particularly low viscosity in the mixture of the two components K1 and K2.

The viscosities of examples V1 and V2 are too low to be suitable for example as cartridge-applied adhesives for bonding of corner angles, frames or profiles in the window, door, container or vehicle construction. In addition, the difference in viscosity between the respective components K1 and K2 was too great, with the result that homogeneous mixing was not achievable using the coaxial cartridge.

1. A two-component composition for use as a free-radically curable adhesive for bonding of corner angles, frames or profiles in window, door, container or vehicle construction composed of a component K1 comprising
a) at least one (meth)acrylate monomer A;
b) at least one elastomer C having (meth)acrylate end groups produced from the reaction of at least one diol D, at least one diisocyanate and a (meth)acrylic acid, a (meth)acrylamide or a (meth)acrylate ester having a hydroxyl group;
c) at least one activator for free-radical curing;
d) at least one inhibitor for free-radical curing;
e) at least one filler;
f) and optionally further additives;
and a component K2 comprising
g) at least one initiator for free-radical curing;
h) at least one filler;
i) at least one plasticizer;
j) and optionally further additives;
wherein the composition contains at least 50% by weight of filler based on the mixture of the components K1 and K2.

2. The two-component composition as claimed in claim 1, wherein the elastomer C is a polyurethane (meth)acrylate produced from the reaction of at least one diol D comprising a polyoxypropylene diol with at least one diisocyanate and one (meth)acrylate ester having a hydroxyl group, wherein
the diol D reacts with a diisocyanate which is present in stoichiometric excess;
and the resulting isocyanate-terminated polyurethane is reacted with the (meth)acrylate ester having a hydroxyl group to afford the elastomer C of formula (I).

3. The two-component composition as claimed in claim 1, wherein the elastomer C has an average molecular weight Mn, measured by gel permeation chromatography, of 1000 to 40 000 g/mol.

4. The two-component composition as claimed in claim 1, wherein the composition in component K1 contains between 0.5% by weight and 2.5% by weight, based on component K1, of the at least one activator for free-radical curing a transition metal complex.

5. The two-component composition as claimed in claim 1, wherein in component K1 the composition additionally contains between 0.5% by weight and 5% by weight, based on component K1, of an adhesion promoter, polyfunctional (meth)acrylates having more than two (meth)acrylate groups and (meth)acrylates of formula (II), 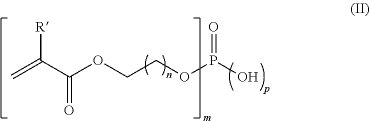
wherein R′ is either a hydrogen atom or a methyl group;
n represents a value of 1 to 15;
m represents a value of 1 to 3;
and p represents a value of 3 minus m;
2-methacryloyloxyethyl phosphate, bis(2-methacryloyloxyethyl)phosphate and tris(2-methacryloyloxyethyl)phosphate and mixtures thereof.

6. The two-component composition as claimed in claim 1, wherein the composition in component K1 contains between 50% by weight and 80% by weight based on component K1, of the at least one filler.

7. The two-component composition as claimed in claim 1, wherein the composition in component K1 additionally contains between 0.001% by weight and 0.5% by weight, based on component K1, of at least one inhibitor for free-radical curing.

8. The two-component composition as claimed in claim 1, wherein component K2 of the composition contains between 5% by weight and 50% by weight, based on component K2, of the at least one initiator for free-radical curing.

9. The two-component composition as claimed in claim 1, wherein (meth)acrylate monomer A comprises at least one monomer selected from benzyl acrylate (BNA), benzyl methacrylate (BNMA), hydroxyethyl acrylate (HEA), hydroxyethyl methacrylate (HEMA), tetrahydrofuryl methacrylate (THFMA), cyclohexyl methacrylate (CHMA), isobornyl methacrylate (IBOMA), trimethylcyclohexyl methacrylate (TMCHMA), lauryl tetradecyl acrylate (LATEA), lauryl tetradecyl methacrylate (LATEMA), stearyl acrylate (STEA), stearyl methacrylate (STEMA) and any desired mixtures thereof, wherein the two-component composition is free from methyl methacrylate (MMA).

10. The two-component composition as claimed in claim 1, wherein component K1 of the composition contains between 5% by weight based on component K1, of the elastomer C.

11. The two-component composition as claimed in claim 1, wherein component K1 of the composition contains, in each case based on component K1,
a) between 10% by weight and 20% by weight of (meth)acrylate monomer A;
b) between 5% by weight and 15% by weight of elastomer C;
c) between 0.5% by weight and 2.5% by weight of the activator for free-radical curing;
d) between 0.001% by weight and 0.5% by weight of the inhibitor for free-radical curing;
e) between 50% by weight and 80% by weight of fillers
f) and optionally further additives.

12. The two-component composition as claimed in claim 1, wherein component K2 of the composition contains, in each case based on component K2,
g) between 5% by weight and 50% by weight of the initiator for free-radical curing;
h) between 10% by weight and 75% by weight of filler;
i) between 10% by weight and 40% by weight of plasticizer;
j) and optionally further additives.

13. The two-component composition as claimed in claim 11,
wherein component K2 of the composition contains, in each case based on component K2,
g) between 5% by weight and 50% by weight of the initiator for free-radical curing;
h) between 10% by weight and 75% by weight of filler;
i) between 10% by weight and 40% by weight of plasticizer;
j) and optionally further additives, and
wherein the two-component composition is composed of the component K1 and the component K2 in a volume ratio K1:K2 of 1:1 to 10:1.

14. A method for using the two-component composition as claimed in claim 1, comprising
bonding corner angles, frames or profiles in window, door, container or vehicle construction with the two-component composition.

15. A process for bonding substrates S1 and S2 comprising the steps of
i) applying a composition as claimed in claim 1 to a substrate S1;
ii) contacting the applied composition with a second substrate S2 within the open assembly time;
or
i′) applying a composition as claimed in claim 1 to a substrate S1;
ii′) applying a composition as claimed in claim 1 to a substrate S2;
iii′) joining the two substrates S1 and S2 to which composition has been applied within the open assembly time;
wherein the second substrate S2 is composed of a material identical or different to that of substrate S1;
and wherein a step I) of the partial or complete mixing of the two components K1 and K2 is carried out before or during step i) or i′) and ii′).
